(19) United States
(12) Patent Application Publication
(10) Pub. No.: US 2023/0179634 A1
(43) Pub. Date: Jun. 8, 2023

(54) SECURE POLICY DISTRIBUTION IN A CLOUD ENVIRONMENT

(71) Applicant: International Business Machines Corporation, Armonk, NY (US)

(72) Inventor: Mark Duane Seaborn, Algonquin, IL (US)

(21) Appl. No.: 17/457,281

(22) Filed: Dec. 2, 2021

(51) Int. Cl. H04L 9/40

(52) U.S. Cl. CPC H04L 63/20; H04L 63/0428; H04L 63/102; H04L 63/101

(57) ABSTRACT

A computer-implemented method for secure policy distribution to a cloud system. The method includes defining an access policy for a set of resources on a cloud computing system, where the access policy includes rules to allow access to the set of resources. The method further includes creating, based on the access policy, an activation function and attribute metadata in the cloud computing system, where the attribute metadata includes a set of access attributes for each resource of the set of resources. The method also includes, receiving a request to access a first resource of the set of resources, where the request includes a set of credentials. The method includes comparing, by the activation function, the set of credentials to the set of access attributes. The method further includes processing, based on the comparing, the request the access the first resource.

### BACKGROUND

The present disclosure relates to access control, and, more specifically, secure policy distribution for scaling cloud services.

Modern cloud computing systems can be very large, very complex, and very demanding environments. Trust and scalability are two factors that can influence the adoption and/or efficiency of cloud systems. As the number of users and/or services provided increases, the risk of breaches and/or performance issues also increases.

### SUMMARY

Disclosed is a computer-implemented method for secure policy distribution to a cloud system. The method includes defining an access policy for a set of resources on a cloud computing system, wherein the access policy includes rules to allow access to the set of resources. The method further includes creating, based on the access policy, an activation function and attribute metadata in the cloud computing system, wherein the attribute metadata includes a set of access attributes for each resource of the set of resources. The method also includes, receiving a request to access a first resource of the set of resources, wherein the request includes a set of credentials. The method includes comparing, by the activation function, the set of credentials to the set of access attributes. The method further includes processing, based on the comparing, the request the access the first resource. Further aspects of the present disclosure are directed to systems and computer program products containing functionality consistent with the method described above.

The present Summary is not intended to illustrate each aspect of, every implementation of, and/or every embodiment of the present disclosure.

### BRIEF DESCRIPTION OF THE DRAWINGS

Various embodiments are described herein with reference to different subject-matter. In particular, some embodiments may be described with reference to methods, whereas other embodiments may be described with reference to apparatuses and systems. However, a person skilled in the art will gather from the above and the following description that, unless otherwise notified, in addition to any combination of features belonging to one type of subject-matter, also any combination between features relating to different subject-matter, in particular, between features of the methods, and features of the apparatuses and systems, are considered as to be disclosed within this document.

The aspects defined above, and further aspects disclosed herein, are apparent from the examples of one or more embodiments to be described hereinafter and are explained with reference to the examples of the one or more embodiments, but to which the invention is not limited. Various embodiments are described, by way of example only, and with reference to the following drawings:

FIG. 1 depicts a cloud computing environment according to an embodiment of the present invention.

FIG. 2 depicts abstraction model layers according to an embodiment of the present invention.

FIG. 3 is a block diagram of a DPS according to one or more embodiments disclosed herein.

FIG. 4 is a functional diagram of a computing environment suitable for secure policy distribution in a cloud system, in accordance with some embodiments of the present disclosure.

FIG. 5 is a flow chart of an example method to securely distribute access policy in a cloud system, in accordance with some embodiments of the present disclosure.

### DETAILED DESCRIPTION

### Cloud Computing in General

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and personal digital assistants (PDAs)).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

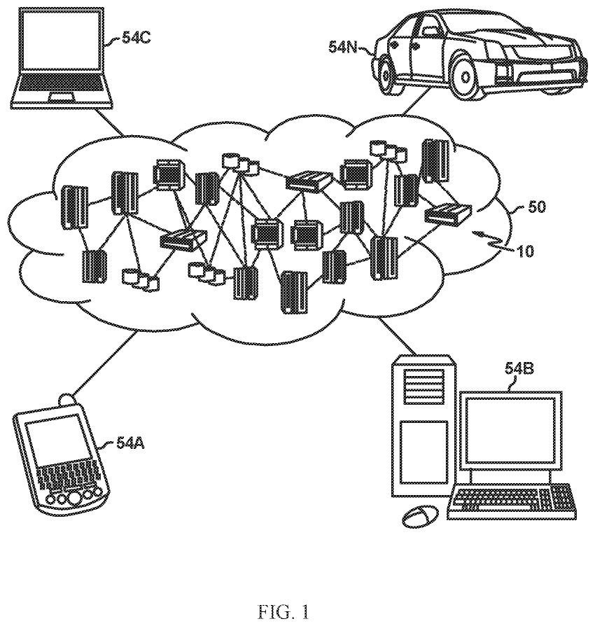

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

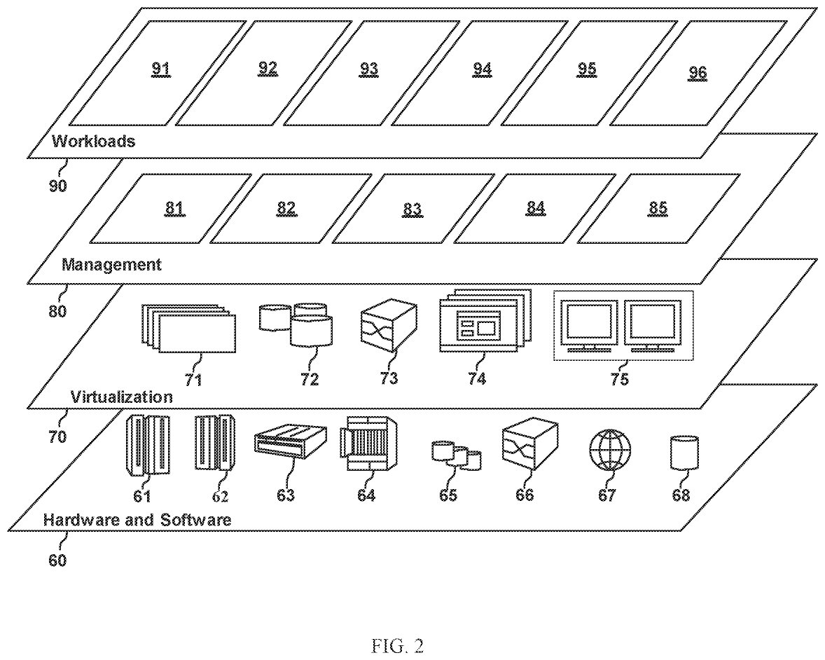

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and object based encryption 96.

Data Processing System in General

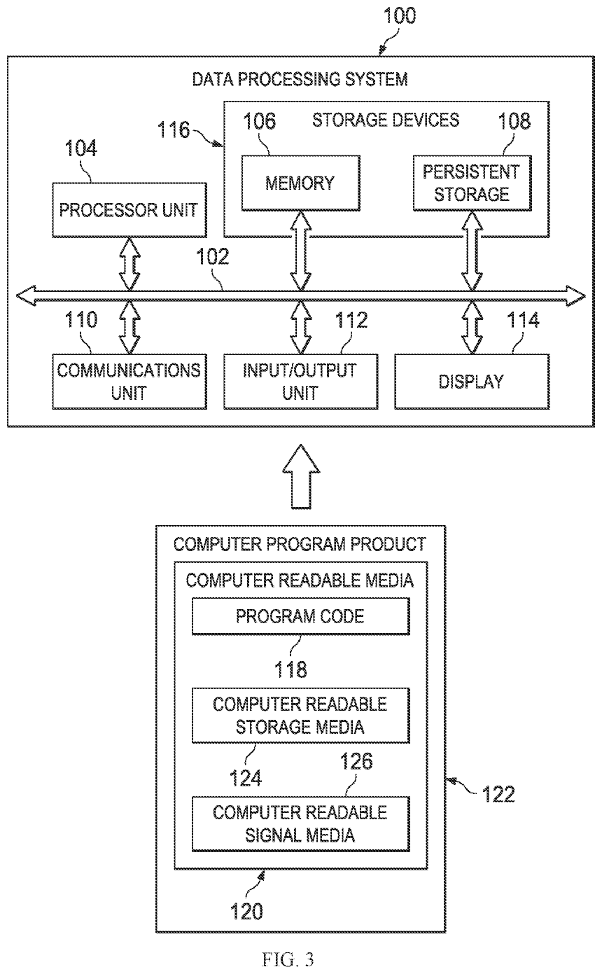

FIG. 3 is a block diagram of an example data processing system (DPS) according to one or more embodiments. The DPS may be used as a cloud computing node 10. In this illustrative example, the DPS 100 may include communications bus 102, which may provide communications between a processor unit 104, a memory 106, persistent storage 108, a communications unit 110, an Input/Output (I/O) unit 112, and a display 114.

The processor unit 104 serves to execute instructions for software that may be loaded into the memory 106. The processor unit 104 may be a number of processors, a multi-core processor, or some other type of processor, depending on the particular implementation. A number, as used herein with reference to an item, means one or more items. Further, the processor unit 104 may be implemented using a number of heterogeneous processor systems in which a main processor is present with secondary processors on a single chip. As another illustrative example, the processor unit 104 may be a symmetric multi-processor system containing multiple processors of the same type.

The memory 106 and persistent storage 108 are examples of storage devices 116. A storage device may be any piece of hardware that is capable of storing information, such as, for example without limitation, data, program code in functional form, and/or other suitable information either on a temporary basis and/or a permanent basis. The memory 106, in these examples, may be, for example, a random access memory or any other suitable volatile or non-volatile storage device. The persistent storage 108 may take various forms depending on the particular implementation.

For example, the persistent storage 108 may contain one or more components or devices. For example, the persistent storage 108 may be a hard drive, a flash memory, a rewritable optical disk, a rewritable magnetic tape, or some combination of the above. The media used by the persistent storage 108 also may be removable. For example, a removable hard drive may be used for the persistent storage 108.

The communications unit 110 in these examples may provide for communications with other DPSs or devices. In these examples, the communications unit 110 is a network interface card. The communications unit 110 may provide communications through the use of either or both physical and wireless communications links.

The input/output unit 112 may allow for input and output of data with other devices that may be connected to the DPS 100. For example, the input/output unit 112 may provide a connection for user input through a keyboard, a mouse, and/or some other suitable input device. Further, the input/output unit 112 may send output to a printer. The display 114 may provide a mechanism to display information to a user.

Instructions for the operating system, applications and/or programs may be located in the storage devices 116, which are in communication with the processor unit 104 through the communications bus 102. In these illustrative examples, the instructions are in a functional form on the persistent storage 108. These instructions may be loaded into the memory 106 for execution by the processor unit 104. The processes of the different embodiments may be performed by the processor unit 104 using computer implemented instructions, which may be located in a memory, such as the memory 106.

These instructions are referred to as program code, computer usable program code, or computer readable program code that may be read and executed by a processor in the processor unit 104. The program code in the different embodiments may be embodied on different physical or tangible computer readable media, such as the memory 106 or the persistent storage 108.

The program code 118 may be located in a functional form on the computer readable media 120 that is selectively removable and may be loaded onto or transferred to the DPS 100 for execution by the processor unit 104. The program code 118 and computer readable media 120 may form a computer program product 122 in these examples. In one example, the computer readable media 120 may be computer readable storage media 124 or computer readable signal media 126. Computer readable storage media 124 may include, for example, an optical or magnetic disk that is inserted or placed into a drive or other device that is part of the persistent storage 108 for transfer onto a storage device, such as a hard drive, that is part of the persistent storage 108. The computer readable storage media 124 also may take the form of a persistent storage, such as a hard drive, a thumb drive, or a flash memory, that is connected to the DPS 100. In some instances, the computer readable storage media 124 may not be removable from the DPS 100.

Alternatively, the program code 118 may be transferred to the DPS 100 using the computer readable signal media 126. The computer readable signal media 126 may be, for example, a propagated data signal containing the program code 118. For example, the computer readable signal media 126 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, the program code 118 may be downloaded over a network to the persistent storage 108 from another device or DPS through the computer readable signal media 126 for use within the DPS 100. For instance, program code stored in a computer readable storage medium in a server DPS may be downloaded over a network from the server to the DPS 100. The DPS providing the program code 118 may be a server computer, a client computer, or some other device capable of storing and transmitting the program code 118.

The different components illustrated for the DPS 100 are not meant to provide architectural limitations to the manner in which different embodiments may be implemented. The different illustrative embodiments may be implemented in a DPS including components in addition to or in place of those illustrated for the DPS 100. Other components are shown in FIG. 1

Modern cloud computing systems can be very large, very complex, and very demanding environments. Trust and scalability are two factors that can influence the adoption and/or efficiency of cloud systems. As the number of users and/or services provided increases, the risk of breaches and/or performance issues also increases. For example, scaling up a service and/or adding a second service requires allocating additional computing resources (e.g., servers, hard drives, processors, etc.) to perform the function. Additionally, most current implementations have the resource storage and the authorization as separate services. To perform a cloud function, there is an additional step of sending the authorization function to an access control system (ACS) to verify access, then returning the authorization to complete the function. In many systems, the ACS is remote, such as a separate cloud system. This can introduce potential bottlenecks and increase the cost of scaling and adding services. The bottlenecks can be based on bandwidth between the authorization system and/or the main cloud system. For the scaling, not only does the main service needs to be scaled, but also the connection and hardware needed to authenticate the additional requests.

Additionally, the extra data transfers can increase security/trust issues. In many current systems, the policies defined in the ACS are not encrypted. That leaves the policy data potentially vulnerable. If a bad actor gains access to the request, they can equate a user with an access level and thereby lead to a potential for phishing attacks of a few high access users. Embodiments of the present disclosure can remedy some of the above-described issues.

Embodiments of the present disclosure include a system and/or a method for secure policy distribution in a cloud service. This can include defining a new metadata structure that contains policies for permitting access to data. In some embodiments, the new metadata structure includes a metadata object attached to a resource, wherein the policy can be resident to data definition. In some embodiments, the new metadata structure can be encrypted that enables the resource authorization function to access assets. One method can be attribute-based encryption.

Embodiments of the present disclosure can include an authorization function that scales efficiently in proportion to the governed resources. The system that uses the authorization function can be durable and secure and be used across a variety of cloud systems. The authorization function can be processed by any resource accessing node in the cloud system.

In some embodiments, the authorization function can be utilized by a resource management node, such as an accessor. The accessor can be a component that manages access to data/functions in a cloud computing environment. In some embodiments, the accessor can operate in conjunction with an access control system (ACS). The ACS can be one or more policies that define rules for permitting access to data and/or authorizations to use/process the data.

In some embodiments, the accessor can enforce the access policy. The access policy can be stored in the ACS. The access policy can define access requirements for data/functions in the cloud system/database. The policy can be defined for any level of specificity and with any number of attributes at each level. For example, there can be attributes at a database level, at a bucket level, and at an object level for an object-based storage. In some embodiments, the access policy can be defined by a data owner.

In some embodiments, the accessor can send/receive the access data to the cloud system/database. The access attributes (or metadata attributes) can be stored as metadata within the remote system and. the attributes are encrypted by an encryption engine. Thus, even if part of the system is compromised, no information can be gleaned about the security policy. In some embodiments, the data owner can send/push the encrypted access data to the cloud system. Thus, the cloud provider cannot access the encrypted policy information. The cloud provider can only perform the enforcement functions. This can increase the overall trust of the cloud system. In some embodiments, the access attributes can be used in a hashing function to prove possession of the attribute and remove the need to pass a token with this sensitive data over the client request channel.

In some embodiments, the accessor receives a request to perform a function on the cloud system/database. In some embodiments, the request includes an authorization credentials. The credentials can include one or more attributes. The attributes can be data that defines information relating to the request. The information can include an account, a user, roles, times of day, location, actions to perform, target data/resources, and the like. In some embodiments, the accessor can compare/evaluate the attributes of the received credentials against the authorization function using policy in the metadata of the source. If the authorization function is successful then access will be granted. If there is a missing attribute the authorization function fails and the access to the resources are denied.

The aforementioned advantages are example advantages, and embodiments exist that can contain all, some, or none of the aforementioned advantages while remaining within the spirit and scope of the present disclosure.

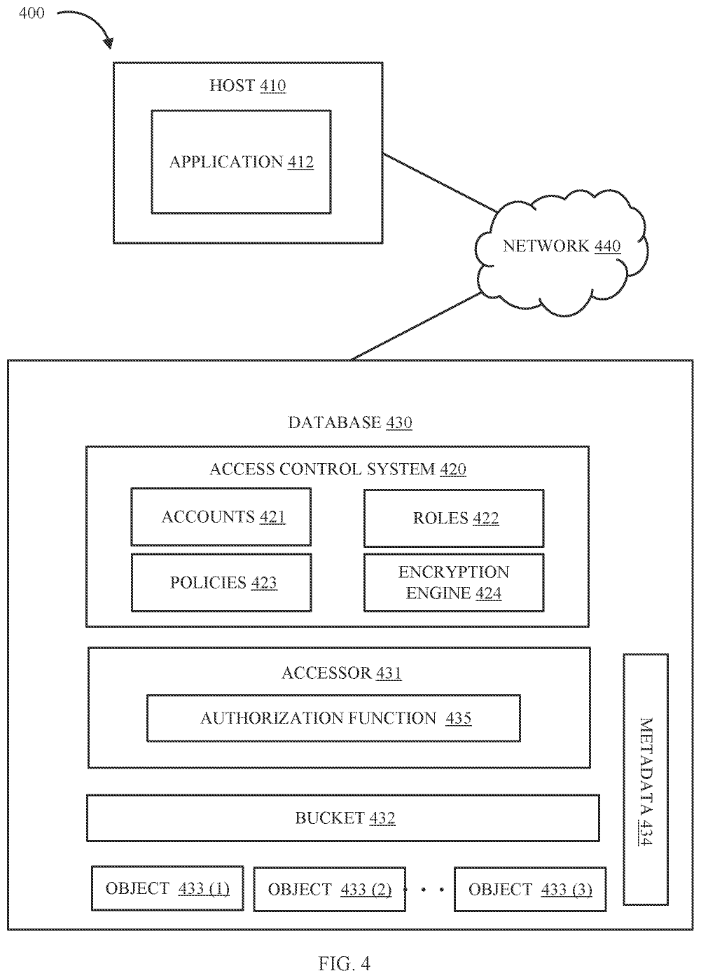

Referring now to various embodiments of the disclosure in more detail, FIG. 4 is a representation of a computing environment 400 that is capable of running an accessor/activation function/policy enforcement function in accordance with one or more embodiments of the present disclosure. Many modifications to the depicted environment may be made by those skilled in the art without departing from the scope of the disclosure.

Computing environment 400 includes host 410, database 430, and network 440. Network 440 can be, for example, a telecommunications network, a local area network (LAN), a wide area network (WAN), such as the Internet, or a combination of the three, and can include wired, wireless, or fiber-optic connections. Network 440 may include one or more wired and/or wireless networks that are capable of receiving and transmitting data, voice, and/or video signals, including multimedia signals that include voice, data, and video information. In general, network 440 may be any combination of connections and protocols that will support communications between and among host 410, database 430, and other computing devices (not shown) within computing environment 400. In some embodiments, each of host 410, and database 430 may include one or more computer systems, such as the data processing system 100 of FIG. 3.

Host 410 can be a standalone computing device, a management server, a web server, a mobile computing device, or any other electronic device or computing system capable of receiving, sending, and processing data. In other embodiments, host 410 can represent a server computing system utilizing multiple computers as a server system, such as in a cloud computing environment (e.g., cloud computing environment 50). In some embodiments, host 410 includes application 412. In some embodiments, host 410 can send a request for cloud services that includes credentials. The credentials can contain/include one or more attributes that define data relating the request. The attributes can be related to an account, a user, an account level, time of the request, location of the request, and the like.

Application 412 can be any combination of hardware and/or software configured to carry out a function on a computing device (e.g., host 410). In some embodiments, application 412 is a web application. In some embodiments, application 412 can be configured to access/process data stored in database 430. Application 412 can be an account-based application. A user or group of users can use one or more accounts to access the data. The access to the processes/data can be based on one or more attributes of each account. In some embodiments, application 412 can be configured to perform one or more functions on a cloud computing network (e.g., the cloud computing environment 50 shown in FIG. 1). In some embodiments, application 412 can generate the request for cloud services. The request can include credentials consistent with the credentials of host 410. There can also be a credential based on the application.

Database 430 can be any combination of hardware and/or software configured to store data. Database 430 includes ACS 420, metadata 434, accessor 431, bucket 432, object 433(1), object 433(2), and up to object 433(n), where n can be an integer representing an object. For purposes of the application, object 433(1), object 433(2), and up to object 433(n) can be referred to as object 433 jointly, severally, and/or individually.

In some embodiments, database 430 includes object storage or object-based storage architecture (or object store). Object storage is a data storage architecture that manages data as objects. Object storage can allow for large amounts of unstructured data to be stored as a single unit/object.

In some embodiments, database 430 includes a file system architecture. A file system architecture can manage data as a hierarchy. Each level and/or branch of the hierarchy can be given one or more attributes to allow access/processing to data in a particular portion of the file system. In some embodiments, database 430 includes a block storage architecture. A block storage architecture can manage data based on the location the data is stored in the storage device. The device can be separated into any number of blocks and/or sub-layers within blocks (e.g., tracks, extents, etc.). Each block and/or sublayer can be correlated to one or more attributes to allow access. In some embodiments, database 430 can be a relational database. A relational database can store data in one or more tables, where each table has columns and rows. Generally, a column will contain a similar type of data, and all data in common rows are related to each other column in the same row. There can also be relationships between two or more tables. In some embodiments, attributes can be correlated to tables, rows, columns, and/or partitions of a relational database to allow access to the data. In some embodiments, database 430 can include metadata that defines attributes that are allowed to access the database. The attributes can be defined by and/or received from ACS 420.

Database 430 is one embodiment of a resource in a cloud system that can utilize the functionality of the present disclosure. In some embodiments, database 430 can be a cloud system with resources available to a remote user. The resource can be any functionality of a cloud system that includes executing various API's and other predefined functionality. The various function can replace the subcomponents of database 430. For example, bucket 432 and object 433 can be replaced with different functions/actions. In some embodiments, ACS 420, metadata 434 and accessor 431 can be present in any cloud system and be used to implement the benefits of this disclosure.

ACS 420 can be any combination of hardware and/or software configured to control access to an application and/or data. The application can be application 412. The data can be stored in database 430. In some embodiments, ACS 420 can be defined and/or updated by a data owner. The ACS 420 can include rules to direct how data and/or resources can be utilized. In some embodiments, ACS 420 includes accounts 421, roles 422, policies 423, and encryption engine 424. In some embodiments, ACS 420 can be wholly incorporated into database 430 and/or accessor 431. For example, the data owner can access database 430 to update and/or define security policy. This incorporation can provide many of the benefits of the present disclosure. It eliminates the need to access a remote ACS that increases the cost of scaling and can lead to potential bottleneck and other availability and service issues.

Accounts 421 can be a set of credentials that are used to perform a function and/or access data. There can be any number of accounts 421 with ACS 420. New accounts can be created, and/or old accounts can be disabled/deleted. Each account of accounts 421 can be associated with a particular user, a group, an entity (e.g., business), a division, and the like. Accounts 421 can be accessed by properly entering credentials associated with each account. In some embodiments, accounts 421 are associated with one or more attributes. In some embodiments, information relating the account/user can be used as one or more credentials.

Roles 422 can be an attribute of accounts 421. There can be any number of roles within ACS 420. In some embodiments, each role has a defined set of attributes/credentials. The attributes allow access to one or more databases, data types, functions, applications, and the like. In some embodiments, each account can be associated with at least one role. Depending on the configuration, an account can have two or more roles or simply a single role associated with the account. In some embodiments, the roles are tiered. Each role can have at least as many permissions/attributes as the lower-tier roles. For example, there can be a basic user, a supervisory user, and an administrator. The administrator can perform all functions and access all data, the supervisory role, a subset of the administrators, and the basic user, a smaller subset of the supervisory role. In some embodiments, the roles can be associated with an action/function. For example, there can be a role for each type of data manipulation and/or application that uses the data. In some embodiments, the roles can be associated with a category of the user of the data. For example, one role can be a data owner and a data user, where the data owner can add and remove data, and the data user can only view the data.

Policies 423 can be rules/definitions to manage the data. Policies 423 can include any number of attributes. The policy can control when and how data is accessed. Attributes can be based on one or more of location, account, user, job title, time of day, date (e.g., weekends, holidays, and workdays can have different attributes), intended use, frequency of access, and the like. In some embodiments, policies 423 can define attributes that must be present in an access request to allow access to the cloud system.

In some embodiments, there is an overlap between the roles 422 and policies 423. In some embodiments, roles 422 and policies 423 can be combined into a single attribute list. The attribute list can include each condition for which accounts/users can have access to the various data. In some embodiments, the attributes can be defined at any level of granularity.

The encryption engine 424 can be any combination of hardware and/or software configured to encrypt and decrypt data. In some embodiments, encryption engine 424 can be located in host 410 and/or database 430 along with ACS 420. In some embodiments, encryption engine 424 can use attribute-based encryption (ABE). ABE is a type of public-key encryption in which the secret key depends upon the attributes of a requestor.

Metadata 434 can be a set of metadata configured to encapsulate access controls to data within database 430. In some embodiments, each level within database 430 can include a unique set of metadata 434. For example, there can be metadata for database 430 as a whole, for bucket 432, and for each of object 433 separately. In some embodiments, metadata 434 can be incorporated into one or more bucket 432, object 433, or any other level/function within database 430. Said differently, each component within database 430 can include a set of metadata 434 specifically configured for the component to which it is attached. The metadata can include attributes of the policy that define how access can be granted to the resource.

In some embodiments, metadata 434 can include one or more attributes that define access to each object/level within database 430. In some embodiments, the attributes can be received from ACS 420 and be based on one or more of accounts 421, roles 422, and policies 423.

In some embodiments, the attributes can be based on the architecture of database 430. For example, in a relational database, the attributes can be a table and/column specific.

Accessor 431 can be any combination of hardware and/or software configured to allow access to data within database 430. In some embodiments, accessor 431 can compare the credentials received with a request for access to the set of attributes for the requested data/function to determine if access is proper. The comparing include/be performed by an authorization function. If the attributes all match the credentials, then access can be granted. In some embodiments, if any of the attributes do not match, then access can be denied. In some embodiments, accessor 431 include authorization function 435. In some embodiments, accessor 431 can, based on a request, identify one or more target resources, and identify the corresponding attributes and/or authorization function.

Authorization function 435 can be any combination of hardware and/or software configured to determine if a request will be allowed or denied. In some embodiments, the authorization function 435. In some embodiments, accessor 431 includes one or more authorization functions 435. There can a unique authorization function for each unique set of attributes that define access any resource in database 430. As such, more than one authorization function can be utilized to gain access for a single object. For example, there can be a unique set of attributes required to access database 430, a second set to access bucket 432, and a third set for object 433. Accessor 431 can compare the credential to the individual authorization functions three times, where each set of attributes corresponds to an individual authorization function. In some embodiments, two or more resources can share the same set of attributes. For example, a first bucket and a second bucket can use the same set of attributes and authorization function. Another example, a bucket and one or more objects in the bucket can share the same the same set of attributes.

In some embodiments, the authorization function 435 can include one or more definitions for attributes that are required to access database 430 and/or a component within database 430. In some embodiments, the attributes from a subset of the attributes defined in ACS 420 are included in the function. The authorization function can include attributes such as the account the user is using, roles assigned to the account, location of generation, time of generation (date, and/or time of day), intended actions (e.g., viewing, adding, deleting, etc.).

In some embodiments, the authorization function can include one or more definitions for attributes that are required to access database 430 and/or a component within database 430.

Bucket 432 can be a data organizations tool. In some embodiments, database 430 can include one or more buckets 432. In some embodiments, bucket 432 can be a container for storing one or more data objects. Bucket 432 can be defined based on one or more attributes. The attributes can be used to allow/disallow actions to be performed/access to an object within the bucket. This can include permissions to add and/or delete objects from bucket 432. In some embodiments, the attributes are included in the metadata of bucket 432. The metadata can be received from ACS 420. The metadata can be based on one or more of accounts 421, roles 422, and policies 423.

Object 433 can be a collection of data that represent a file. Each object can include a unique identifier, some amount of metadata, and the data that forms the object. The object can be any type of file (e.g., word processing doc, spreadsheet, photo, video, etc.). Each object 433 can include attribute metadata. The attribute metadata can be received from ACS 420. The attributes metadata can define when access is allowed for the data in the object. The metadata can be based on one or more of accounts 421, roles 422, and policies 423.

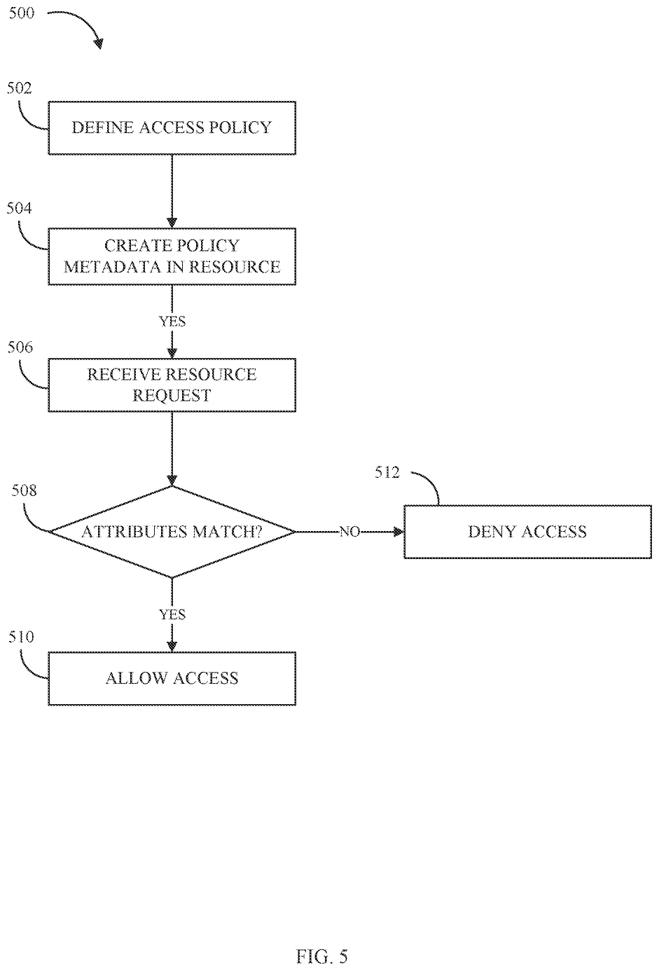

FIG. 5 depicts a flowchart of an example method, method 500, for scalable access management of data that can be performed in a computing environment (e.g., computing environment 400 and/or cloud computing environment 50). One or more of the advantages and improvements described above for scalable access management may be realized by method 500, consistent with various embodiments of the present disclosure.

Method 500 can be implemented by one or more processors, host 410, application 412, ACS 420, accounts 421, roles 422, policies 423, the encryption engine 424, database 430, accessor 431, bucket 432, object 433, metadata 434, and/or a different combination of hardware and/or software. In various embodiments, the various operations of method 500 are performed by one or more of, host 410, application 412, ACS 420, accounts 421, roles 422, policies 423, the encryption engine 424, database 430, accessor 431, bucket 432, object 433, metadata 434. For illustrative purposes, the method 500 will be described as being performed by accessor 431.

At operation 502, the accessor 431 defines an access policy. In some embodiments, the access policy can be defined in ACS 420. The access policy can be directed to data that is stored in a cloud computing system and/or to functions performed on a cloud computing system. In some embodiments, the policy can include accounts 421, roles 422, and/or policies 423.

In some embodiments, the access policy defines attributes and/or credentials that must be present in a request to allow access to the data/function. Each portion of the data, based on the architecture, can have any number of attributes. The data can be separated and have the same or different attributes at any granularity. For example, in an object-based storage architecture, the attributes can be set at the database, bucket, object, and/or any other level within the storage hierarchy. For a relational database, the attributes can be at the database, partition, table, column, and/or row levels. There can be any number of attributes defined for any level. In some embodiments, the attributes are defined by a data owner. The policies/attributes can be updated by the data owner at any time.

In some embodiments, operation 502 includes defining one or more authorization functions. There can be any number of authorization functions. In some embodiments, the number of authorization functions can be the same as the number of unique sets of attributes defined to allow access to the various resources.

At operation 504, accessor 431 stores the defined attributes/policy in the database. In some embodiments, the attributes are stored as metadata. There can be unique/separate metadata for each level/object/application in the cloud system. In some embodiments, the metadata can be stored with the target data. For example, in object storage, metadata is already used to define the object. The attribute metadata can be added to the existing metadata. The policy/attribute metadata can include the same encryption and security standards as the object. In some embodiments, operation 504 includes attaching the attributes for each resource to the resource as metadata. This can include the authorization function. In some embodiments, the attributes/policy can be encrypted. The encryption process can be performed by encryption engine 424.

At operation 506, accessor 431 receives a request to access resources in the cloud system. In some embodiments, the request/query is configured to utilize data within a database (e.g., database 430). In some embodiments, the request can be directed to any resource of any node of a cloud system. The data can be stored and/or in a cloud computing system (e.g., remote from the source of the request). The utilization can be access, view, update, add, delete, and/or other actions that use the data. In some embodiments, the request can include a set of credentials. The set of credentials can include any number of attributes. The credentials (or credential attributes) can be information about the source of the request. The information can include account, users, roles of the account, time requested, functions to perform, and the like. In some embodiments, the set of credentials is based on the data in ACS 420.

In some embodiments, operation 506 includes identifying each resource requested. In some embodiments, operation 506 include identifying each set of attributes that must be checked to grant access to the resource. For example, a single request can request access to a service, to a bucket and to a function. Each of these may have a different set of attributes attached. accessor 431 can determine that there will be three sets of attributes to check against the credential

At operation 508, accessor 431 determines if each of the attributes in the authorization function is included within the credentials of the request is met by the. In some embodiments, the determination is based on comparing the credentials in the request to the attributes for the data (e.g., the attribute metadata). In some embodiments, the comparing includes a hash function. The credentials can be a key to the hash function, where a key identifies if hashed with the attributes to show proof of possession of the correct credentials. If each of the required attributes in the attribute metadata is contained in the credentials, then access can be grated. It is possible to place more credentials in the request than required to access the data. For example, the request can include a time credential, but no policy defines any time for access. In some implementations, the security attribute can be set to any value, so the extra credential does not prevent access unintentionally.

If it is determined the request attributes match the metadata attributes (508:YES), then accessor 431 proceeds to operation 510. If it is determined the request attributes do not match the metadata attributes (508:NO), then accessor 431 proceeds to operation 512.

At operation 510, accessor 431 allows the request to be completed. In some embodiments, operation 510 can include returning the results of the request to the source, and/or granting access to a cloud service.

At operation 512, accessor 431 denies/prevents the request from being completed. In some embodiments, the denial can include returning an indication of denial. This can include an error message, not authorized message, and/or returning nothing.

In some embodiments, method 500 can be separated into two or more separate methods. For example, operations 502 and 504 can be a first method and the remaining operation a second method. As such, a data owner can define a policy and send it to two or more different databases/cloud systems. This can be useful if a data owner utilizes multiple cloud providers and/or if they desire different security standards and processes on different databases. In another example, the first method can be executed once and allow for the second method to be used several times for each request. Once the policy is updated/redefined, the new attribute metadata can be sent to the cloud system, and the second method continues with the new data.

In some embodiments, several iterations of various operations can be performed. For example, if a request requires access to a service, a bucket, and an object that each have a unique set of attributes, then the credentials will be checked against each set of attributes. In some embodiments, accessor 431 starts at the highest level, once access is granted, accessor can repeat operations 506-510 for each unique set of attributes.

Method 500 can provide several benefits. One benefit is that it does not require (or eliminates) a need to contact the ACS 220 when a request is received. This can provide for the scalability of the cloud system. If the ACS 420 did need to be contacted, for every increase in usage/services at the cloud system, the bandwidth and capacity to verify proper access with ACS 420 would also need to be scaled up. Sending the attributes as metadata to the cloud system can increase scalability. The cost of adding the metadata is virtually nil compared to upgrading bandwidth and processing to validate proper access on a remote system.

Another advantage of the various embodiments described here in is that they provides increased security and trust. The attribute metadata can be encrypted with keys controlled by the data owner. Then if there is any breach of the system, the portions of the policy, including the request and source of the request, can be encrypted. Having to call a remote ACS 420 can leave portions of the policies unencrypted. If this data is nefariously obtained, it can be used to identify phishing targets among other undesired outcomes.

### Computer Technology and Computer Readable Media

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
defining an access policy for a set of resources on a cloud computing system, wherein the access policy includes rules to allow access to the set of resources;
creating, based on the access policy, an activation function and attribute metadata in the cloud computing system, wherein the attribute metadata includes a set of access attributes for each resource of the set of resources;
receiving a request to access a first resource of the set of resources, wherein the request includes a set of credentials;
comparing, by the activation function, the set of credentials to the set of access attributes; and
processing, based on the comparing, the request the access the first resource.

2. The method of claim 1, further comprising:
determining the set of credentials matches the set of access attributes; and
wherein processing includes allowing access to the resource in response to the determining the credentials matches the access attributes.

3. The method of claim 1, further comprising:
determining the set of credentials does not match the set of access attributes; and
wherein the processing includes denying access to the resource in response to the determining the credentials do not match the access attributes.

4. The method of claim 1, wherein the attribute metadata is encrypted by an encryption engine.

5. The method of claim 4, wherein attribute based encryption is used to encrypt the attribute metadata.

6. The method of claim 4, wherein the resource includes accessing data stored as an object based storage.

7. The method of claim 6, wherein the object based storage includes at least a bucket level with one or more buckets, and an object level with one or more object in each bucket, and the attribute metadata can include a least one attribute for each bucket and at least one attribute for each object.

8. The method of claim 4, wherein the metadata attributes are selected from a group consisting of, an account type, an account role, a time, request location, and a type of requested resource.

9. The method of claim 4, wherein the metadata attributes include an account type, an account role, a time, a request location, and a type or requested resource.

10. The method of claim 4 wherein the attribute metadata includes attributes at a table level and at a column level.

11. The method of claim 1, wherein each resource of the set of resources has a unique activation function.

12. A system comprising:
a processor; and
a computer-readable storage medium communicatively coupled to the processor and storing program instructions which, when executed by the processor, are configured to cause the processor to:
define an access policy for a set of resources on a cloud computing system, wherein the access policy includes rules to allow access to the set of resources;
create, based on the access policy, an activation function and attribute metadata in the cloud computing system, wherein the attribute metadata includes a set of access attributes for each resource of the set of resources;
receive a request to access a first resource of the set of resources, wherein the request includes a set of credentials;
compare, by the activation function, the set of credentials to the set of access attributes; and
process, based on the comparing, the request the access the first resource.

13. The system of claim 12, wherein the processor is further configured to the cause the processor to:
determine, by the activation function, the set of credentials matches the set of access attributes; and
wherein processing includes allowing access to the resource in response to the determining the attributes match.

14. The system of claim 12, wherein the processor is further configured to the cause the processor to:
determine the set of credentials does not match the set of access attributes; and
wherein the processing of the request includes denying access to the resource in response to the determining the attributes do not match.

15. The system of claim 12, wherein the creating the attribute metadata includes receiving from the access policy from an access control system, and the comparing is completed without sending the request to the access control system.

16. The system of claim 12, wherein the attribute metadata is encrypted by an encryption engine, the attribute based encryption is used to encrypt the attribute metadata, and the resource includes accessing data stored as an object based storage.

17. A computer program product, the computer program product comprising a computer readable storage medium having program instructions embodied therewith, the program instructions executable by a processing unit to cause the processing unit to:
define an access policy for a set of resources on a cloud computing system, wherein the access policy includes rules to allow access to the set of resources;
create, based on the access policy, an activation function and attribute metadata in the cloud computing system, wherein the attribute metadata includes a set of access attributes for each resource of the set of resources;
receive a request to access a first resource of the set of resources, wherein the request includes a set of credentials;
compare, by the activation function, the set of credentials to the set of access attributes; and
process, based on the comparing, the request the access the first resource.

18. The computer program product of claim 17, wherein the processor is further configured to the cause the processing unit to:
determine the set of credentials matches the set of access attributes; and
wherein processing includes allowing access to the resource in response to the determining the attributes match.

19. The computer program product of claim 17, wherein the processor is further configured to the cause the processing unit to:
determine the set of credentials does not match the set of access attributes; and
wherein the processing of the request includes denying access to the resource in response to the determining the attributes do not match.

20. The computer program product of claim 17, wherein the first resource has a first set of access attributes, and the set of credentials are checked by a first activation function; and
the request to access a first resource include a second request to access a second resource of the set of resources, the second resource has a second set of attributes, and the set of credentials are checked by a second activation function.
